(19) United States
(12) Patent Application Publication
(10) Pub. No.: US 2006/0042411 A1
(43) Pub. Date: Mar. 2, 2006

(54) Steering system

(76) Inventors: Wolfgang Abele, Spraitbach (DE); Arnulf Heilig, Schwaebisch Gmuend (DE)

Correspondence Address: KENYON & KENYON, ONE BROADWAY, NEW YORK, NY, 10004, US

(21) Appl. No.: 11/219,509

(22) Filed: Sep. 1, 2005

(30) Foreign Application Priority Data
Sep. 1, 2004 (DE) 10 2004 042 243.5

(51) Int. Cl. F16H 19/04

(52) U.S. Cl. 74/29

(57) ABSTRACT

A steering system for a vehicle, e.g., a power-steering system for a motor vehicle, includes a gear unit, which converts a rotational movement of a first gear element, such as a pinion, to an axial shifting movement of a rod or gear rack. The gear unit is used for adjusting the steering angle of one or more wheels of the motor vehicle. The shifting movement of the rod occurs between a first limit stop and a second limit stop and is detected by a position sensor. To reliably detect and determine the position of the rod and the steering angle while simultaneously being able to limit the travel of the rod in a controlled manner, it is provided that, on the rod or a component part of the steering system movable with the rod, a first reference information item or a pair of reference marks are positioned at a first defined distance from each other in the vicinity of the first limit stop of the rod and a second reference information item or a second pair of reference marks are spaced apart by a second defined distance in order to be detected by the position sensor, and that the signals of the position sensor are combined with the signals of an angle-of-rotation sensor for the first gear element or for a servomotor of the steering system.

### CROSS-REFERENCE TO RELATED APPLICATIONS

The present application claims priority to Application No. 10 2004 042 243.5, filed in the Federal Republic of Germany on Sep. 1, 2004, which is expressly incorporated herein in its entirety by reference thereto.

### FILED OF THE INVENTION

The present invention relates to a steering system for a vehicle, e.g., a power-steering system for a motor vehicle.

### BACKGROUND INFORMATION

A variety of design approaches are believed to be conventional for detecting the position of an axially movable rod, gear rack, steering spindle, or piston rod in steering systems of vehicles. The detection of the position of the rod is used for determining a rotational angle of a steering handle of the steering system, and for limiting the travel of the rod in a controlled manner.

European Published Patent Application No. 0 410 583 describes a device for detecting the position of a gear rack in a steering gear as a measure of the steering angle, where surface characteristics of the gear rack are detected by a magnetoresistive sensor as a measure of the gear-rack position. As an alternative, the position of a sliding rod that is axially movable with the gear rack, as well as the tapered ferromagnetic surfaces of the sliding rod, can be detected with the aid of the magnetoresistive sensor. The signals of the magnetoresistive sensor are indicated or read via an amplifier circuit.

German Published Patent Application No. 102 22 761 describes a rack-and-pinion steering system in which the position of the gear rack is detected, e.g., a steer-by-wire system, which may detect the position of the gear rack via linear sensors and has, at the same time, a device for limiting the travel of the gear rack in the sense of electronic, controlled, end-stop limitation of the gear rack.

German Published Patent Application No. 197 54 278 describes a steering system for a vehicle, e.g., a power-steering system for a motor vehicle, having a steering gear that converts a rotational movement of a first gear element taking the form of a pinion, into an axial displacement of a rod taking the form of a gear rack. The gear rack is connected in series to a piston rod of a hydraulic servo cylinder. The gear rack and the piston rod can be moved between a first and a second axial limit stop. At least one position sensor, e.g., two position sensors situated on the servo cylinder so as to be spaced apart, detect the location of the piston and, therefore, the path of movement and the position of the gear rack. A control unit having an electronic control valve damps and retards the sliding movement of the piston when it approaches an axial limit stop, and/or reduces the feed rate of a hydraulic pump of the steering system.

Conventional steering systems, in which the displacement and position of a rod for adjusting the steering angle of a wheel are detected, are either special solutions or may use expensive sensors such as linear sensors, or, in the case of using exclusively periodic, angular-position sensors, may not be reliable for detecting the absolute position of the rod and, therefore, for determining a steering angle of a steering handle of the steering system.

### SUMMARY

An example embodiment of the present invention may provide a steering system, which may allow a steering angle to be detected and determined in a simple and reliable manner and may allow the travel of a rod for adjusting the steering angle of a wheel to be limited in a controlled manner with low energy absorption.

In order to reliably determine the magnitude and direction of the steering angle and limit the travel of the rod in a controlled manner, it may be provided that, on the rod or on a component that may move with the rod in the same direction, a first reference information item and a second reference information item be positioned in the vicinity of the first limit stop and the second limit stop, respectively, the second limit stop being opposite to the first limit stop. The optical, mechanical, magnetic or other types of characteristic features, which are at the specific location of the rod and change it, are designated as reference information items. An open-loop and/or closed-loop control device combines the signals of the position sensor generated by the reference information items with periodic signals of an angular-position sensor, which may have a high resolution and may measure the rotation of the first gear element or the rotation of a shaft of a servomotor of the steering system, which means that when the position sensor that is fixed with respect to the rod is swept over by the reference information items, the specific position of the rod may be reliably detected. Consequently, the position of the rod may be reliably detected, and the angular-position sensor may be calibrated absolutely.

The reference information items imprinted or engraved into the rod may each be formed by a notch in the vicinity of the limit stops of the rod. In this context, the edges of the notches may be formed so as to be at a different distance from each other.

It may also be provided to form the edges of the two notches so as to be at the same distance from each other, in which case a third reference information item is provided, in each instance, for detecting the position of the rod from the center, between the notches, the third reference information item being able to be formed, in turn, by edges of a notch or by characteristic features of the rod, such as one or two axial grooves, or tracks, which generate uniform position-sensor signals different from each other and extend to the first and second reference information items.

The third or fourth reference information item may be a groove of constant depth introduced into the rod in the axial direction. It may also be provided to make the third and fourth reference information items out of one axial groove each, the grooves being staggered in the tangential direction of the rod, and each groove being assigned a measuring element of the position sensor for detecting the respective groove. This allows a binary code to be produced on the rod.

The first, second, and third reference information items may be made of a first pair of reference marks having defined spacing, a second pair of reference marks having defined, different spacing, and a third pair of reference marks having different, defined spacing.

In order to utilize the signals of the position sensor for, e.g., limiting the travel of the rod in an electronically controlled manner, the first and second reference information items or the first and second pairs of reference marks may be positioned at the same distance from the limit stops, on the rod or the component part that may slide with it in the same direction. The absolute steering angle information acquired in this manner may be used for damping the mechanical limit stop and for actively reversing the rod. To rapidly detect the absolute steering angle, it may be provided to centrally position a further reference-information item on the rod or the component part, between the first limit stop and the second limit stop. In each instance, the open-loop and/or closed-loop control device induces the damping and/or a limitation of the travel of the rod after a reference-information item or a pair of reference marks sweeps over the position sensor, by controlling the servomotor that moves the rod. The positions of the reference information items or reference marks on the rod or on the component part that moves with it are stored in a memory device of the open-loop and/or closed-loop control device or of the steering system. The rotational-angle information belonging to each measured value is stored there, as well. The defined distance of the first and second reference information items or reference marks from the corresponding mechanical limit stop of the rod may provide for user-friendly operation of the steering system.

In order to prevent erroneous calibration during initial operation of the steering system, where the position of the position sensor is approximately between the specific mechanical limit stop and the outer reference mark adjacent to it, or the first or second reference-mark pair, or the first and second reference information items, it may be provided that the steering system may be formed such that at least one component of the steering system exerts a restoring force on the rod, whereby in relation to the position sensor, the rod comes to rest between the first and second reference-mark pairs or between the first and second reference information items. This may ensure a defined starting position of the rod and its reference-mark pair or reference information items with respect to the position sensor.

The rod may be a gear rack of a rack-and-pinion power steering system of a motor vehicle. Nevertheless, the rod may be a part of a ball-and-nut rotary steering system, or part of a steering actuator of an electric or electrohydraulic steering system, or a tie rod of a power-steering system, etc.

The rod of the steering system or the steering-system component part that may move with the rod may also be a piston rod of a hydraulic servomotor. The reference marks or reference information items may be formed by design features of the rod, such as bores, depressions, etc. It may also be provided for the imprinted reference information items to take the form of magnetic or optical codes as a function of the selected design of the position sensor (magnetoresistive, Hall, optical sensor, etc.).

To rapidly detect the absolute steering angle with the aid of reference marks or reference information items on the rod, it may be provided to position more than three pairs of reference marks or three reference information items on the rod or on the steering-system component part that moves with the rod. The pairs of reference marks or reference information items may be spaced apart from one another at a distance, which may correspond to, for example, an angle of rotation of approximately 90° at the steering handle of the steering system.

The position sensor may be arranged in the center of the displacement path of the rod and, e.g., at the location at which a contact piece or pressure plate radially loads the rod. The position sensor may be integrated in the pressure plate. It may also be provided to arrange the position sensor next to the first gear element, e.g., next to a pinion, which meshes with a rod taking the form of a gear rack. If the rod takes the form of a gear rack, then it may be provided to use the teeth or changes in shape at the teeth of the gear rack as reference marks or reference information items. In the vicinity of the first limit stop of the gear rack, two consecutive teeth may form the first pair of reference marks or the first reference information item, and at the second limit stop, two teeth spaced apart by one tooth may form the second pair of reference marks or the second reference information item.

In addition to the described method for determining the position of the rod or a steering angle of a wheel of the vehicle, an auxiliary circuit may be provided in the steering system. The auxiliary circuit may consume a small amount of energy and may be able to detect changes in the position of the rod or changes in the steering angle resulting from moving a steering handle of the vehicle when the ignition is switched off, e.g., counting out-of-phase sinusoidal signals of the angle-of-rotation sensor. When the ignition of the vehicle is switched off, the magnitude and the direction of the signals of the angle-of-rotation sensor are stored, for example, in the memory of the steering system. After the ignition is switched on, the stored values are combined with current signals of the angle-of-rotation sensor, and the position of the rod or the magnitude of steering angle, which may have changed while the ignition was switched off, may be determined in a highly accurate manner.

When the ignition is switched off, the signals of the angle-of-rotation sensor for the first gear element or for an output shaft of the servomotor of the steering system is periodically measured at an interval of, e.g., approximately 10 ms. After every change in the signal of the angle-of-rotation sensor, the auxiliary circuit and/or the counter remains in an activated mode. The increment of the signals of the angle-of-rotation sensor may be a 45° angle of rotation of the first gear element or the output shaft of the servomotor of the steering system. The absolute rotational angle of the first gear element or the output shaft of the servomotor (absolute rotor angle) may be determined by the steering system of the present invention with an accuracy of, e.g., approximately 2° or better.

The steering angle ascertained by the open-loop and/or closed-loop control device, or the position of the rod, may be continuously validated by the signals of the position sensor for the rod. Consequently, a malfunction of the auxiliary circuit and/or the counter may be reliably detected. The functionality of an external steering-angle sensor may also be tested with the aid of the auxiliary circuit and/or the counter.

The described manner of detecting the position of the rod and, therefore, of determining the absolute rotational angle of the first gear element or the steering handle or the shaft of the servomotor, in connection with the controlled, e.g., electronically controlled limitation of the travel of the rod, may be suited for use in an electrically-assisted power steering system or a steer-by-wire system, since in this case, the present rotor-speed sensor of the servomotor may be used as an angle-of-rotation sensor.

Example embodiments of the present invention are described in more detail below with reference to the appended Figures.

### BRIEF DESCRIPTION OF THE DRAWINGS

FIG. 1 is a schematic block diagram of a steering system according to an example embodiment of the present invention.

FIG. 2 illustrates the signal sequence of the sensors of the steering system illustrated in FIG. 1.

FIG. 3 illustrates a further signal sequence of a steering system.

FIG. 4 is a top view of a rod in an additional steering system, and a corresponding signal sequence.

FIG. 5 are cross-sectional views of the rod illustrated in FIG. 4.

### DETAILED DESCRIPTION

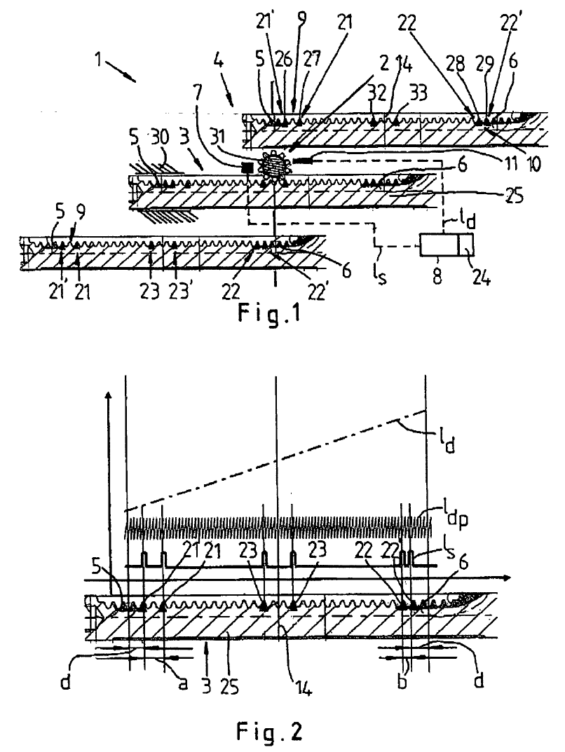

In FIG. 1, a steering system 1 for a motor vehicle is illustrated in a schematic block diagram. Steering system 1 is illustrated as a rack-and-pinion power steering system, a gear unit 4 being used for converting a rotational movement of a first gear element 2 to an axial displacement of a rod 3 in a gear housing 30. Rod 3 takes the form of a gear rack 25, with which first input-side gear element 2 taking the form of a pinion 31 meshes. Gear rack 25 may move between a first axial limit stop 5 and a second, opposite, axial limit stop 6. Gear rack 25 is connected to tie rods and pitman arms of steerable wheels of the motor vehicle for adjusting their steering angle. A rotational movement or adjusting movement introduced at a steering handle, such as a steering wheel of the motor vehicle, induces a rotational movement of pinion 31 via an electronic coupling of the steering handle to a servomotor, which may be conventional. The direction and revolutions per unit time of the angular motion of pinion 31 or the servomotor shaft are detected by a angle-of-rotation sensor 11, and an angle-of-rotation signal I_{d} is transmitted to a open-loop and/or closed-loop control device 8 of steering system 1. In FIG. 2, integrated angle-of-rotation signal I_{d} is illustrated changing linearly as a function of the gear-rack position. The angle-of-rotation signal increases from a first, right mechanical limit stop 5 to a second, left mechanical limit stop 6.

A position sensor 7 is arranged next to pinion 31 in gear housing 30, over the gear teeth of gear rack 25, and detects a first pair of reference marks 21, 21′, a second pair of reference marks 22, 22′, and a third pair of reference marks 23, 23′ arranged in the center 14 of gear rack 25. First and second pairs of reference marks 21, 21′ and 22, 22′ and, e.g., their second, outer reference marks 21′ and 22′ are positioned at the same distance d from first and second mechanical limit stops 5, 6, near the limit stops.

First and second pairs of reference marks 21, 21′ and 22, 22′ are used for detecting the absolute position of gear rack 25 and for showing the controlled limitation of the travel of gear rack 25, e.g., by open-loop and/or closed-loop control device 8. The signal pattern of signal Iₛ of position sensor 7 is illustrated in FIG. 2. The two signals Iₛ and I_{d} are supplied to open-loop and/or closed-loop control device 8 and combined, in order to allow angle-of-rotation signal I_{d} to be adjusted or calibrated, and to obtain a continuous, exact determination of the position of gear rack 25 and the steering handle over the displacement path of gear rack 25.

If first, inner reference mark 21, 22 is detected by position sensor 7, the internal rotational-angle information from periodic signal I_{dp} of angle-of-rotation sensor 11 (cf., FIG. 2) is stored in a memory 24. Upon reaching the respective, second, outer reference marks 21′, 22′, which are positioned at distance d from limit stops 5, 6 of gear rack 25, the position at which gear rack 25 is currently located is determined by open-loop and/or closed-loop control device 8 with the aid of the internal rotational-angle information and the direction of rotation of pinion 31. The position of gear rack 25 at its left, second mechanical limit stop 6 is illustrated at the bottom of FIG. 1, and the position of gear rack 25 at its right, first mechanical limit stop 5 is illustrated at the top of FIG. 1.

In the exemplary embodiment illustrated, all reference marks 21, 21′, 22, 22′, 23, 23′ are formed by teeth 26, 27, 28, 29, 32, 33 of gear rack 25, and by design features on the teeth, such as bores, depressions, notches, etc. First pair of reference marks 21, 21′ is formed by two directly consecutive teeth 26, 27 having spacing (a), while second pair of reference marks 22, 22′ is formed by two teeth 28, 29 having a spacing (b) of one tooth between them. Third pair of reference marks 23, 23′ is formed by two teeth 32, 33 having a spacing of two teeth.

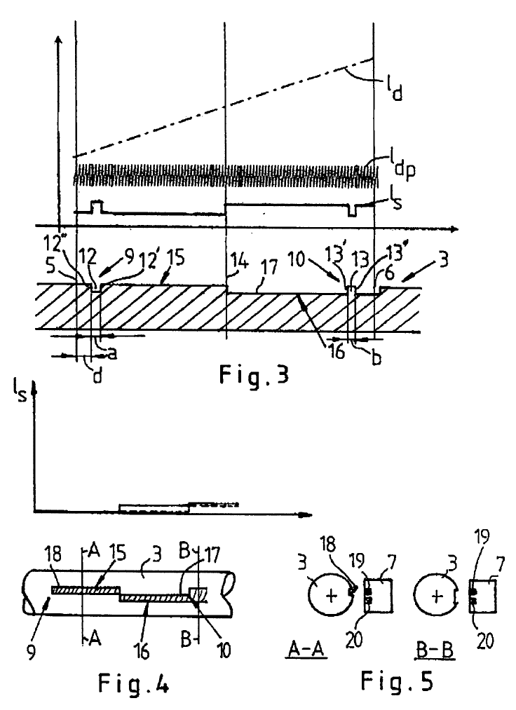

Illustrated in FIG. 3 is a longitudinal cross-section of a rod 3 of a further steering system, and a corresponding signal sequence. In the vicinity of its first limit stop 5, rod 3 has a reference information item 9 in the form of a notch 12. In the vicinity of its second limit stop 6, rod 3 has a second reference information item 10 in the form of a second notch 13. Edges 12′, 13′ facing center 14 of rod 3 and edges 12″, 13″ facing corresponding limit stop 5, 6 have the same spacing (a), (b). Second notch 13 illustrated as a special case is inversely represented, so that in this manner, an option independent of the specific position of positioned sensor 7 with respect to rod 3 is given of being able to continuously and immediately detect the rod position after initial operation of, and during operation of, steering system 1.

In the example illustrated, position sensor 7 detects notch 12 as logical “1” to the left of center 14, and as logical “0” to the right of center 14. Third reference information item 15 and fourth reference information item 16, which define notches 12, 13 and extend to the left and right of center 14 to notches 12, 13, generate uniform signals different from each other. In the exemplary embodiment illustrated in FIG. 3, a groove 17 of constant depth extending into or in rod 3 from center 14 to edge 13′ of notch 13 forms fourth reference information item 16.

As illustrated in FIG. 4, a further groove 18, which is tangentially offset by the width of a groove and extends from center 14 to the left, may form third reference information item 15. Grooves 17, 18 illustrated in FIG. 4 are each detected by one measuring element 19, 20 of position sensor 7, in which case the signal sequence illustrated at the top of FIG. 4 results. The measuring elements may be Hall-effect sensors. FIG. 5 illustrates two cross-sections A-A, B-B of rod 3 in FIG. 4.

What is claimed is:

1. A steering system for a vehicle, comprising:
a gear unit adapted to convert rotation movement of a first gear element to an axial displacement of a rod to adjust a steering angle of a wheel, the rod movable between a first limit stop and a second limit stop;
a position sensor adapted to detect a position of the rod; and
at least one of (a) an open-loop and (b) a closed-loop control device;
wherein one of (a) the rod and (b) a component part of the steering system movable with the rod includes a first reference information item in a vicinity of the first limit stop and a second reference information item in a vicinity of the second limit stop to detect the position of the rod by the position sensor, the control device adapted to combine signals of the position sensor with signals of an angle-of-rotation sensor of one of (a) the first gear element and (b) a servomotor of the steering system.

2. The steering system according to claim 1, wherein the steering system is configured as a power-steering system.

3. The steering system according to claim 1, wherein at least one of (a) the first reference information item and (b) the second reference information item is one of (a) engraved and (b) imprinted on the one of (a) the rod and (b) the component part of the steering system movable with the rod.

4. The steering system according to claim 1, wherein the first reference information item and the second reference information item include edges of a first notch having a first spacing and edges of a second notch having a second spacing different from the first spacing.

5. The steering system according to claim 1, wherein first reference information item and the second reference information item include edges of a first notch and edges of a second notch, edge spacings of the first notch and second notch being equal, a third reference information item and a fourth reference information item, formed as one of (a) edges of a notch and (b) characteristic features of the rod adapted for generate a uniform position-sensor signal different from each other, respectively extending from a center, between the first notch and second notch, to the first notch and the second notch.

6. The steering system according to claim 5, wherein one of (a) the third reference information item and (b) the fourth reference information item includes a groove arranged in the rod in an axial direction.

7. The steering system according to claim 5, wherein each of the third reference information item and the fourth reference information item includes an axial groove, the grooves staggered in a tangential direction of the rod, each groove corresponding to a measuring element of the position sensor adapted to detect the corresponding groove.

8. The steering system according to claim 1, wherein the first reference information item and the second reference information item include a first pair of reference marks having a first defined distance of the first pair of reference marks from each other and a second pair of reference marks having a second defined distance of the second pair of reference marks different from the first defined distance.

9. The steering system according to claim 1, wherein the first reference information item and the second reference information item are positioned a same distance away from the first and second stop limits.

10. The steering system according to claim 1, wherein a third pair of reference marks are centrally position on the one of (a) the rod and (b) the component part of the steering system movable with the rod between the first limit stop and the second limit stop.

11. The steering system according to claim 1, further comprising an arrangement adapted to store the signal of the angle-of-rotation sensor in response to a detection by the control device of one of (a) a first edge and (a) a reference mark at one of (a) the first limit stop and (b) the second limit stop and to unequivocally determine the position of the rod in response to a detection of one of (a) a second edge and (b) a second reference mark.

12. The steering system according to claim 1, further comprising an arrangement adapted to define a limitation of travel of the rod after detection by the position sensor of one of (a) the first reference information item, (b) the second reference information item, (c) a first pair of reference marks and (d) a second pair of reference marks.

13. The steering system according to claim 1, further comprising a memory adapted to store an absolute position of one of (a) reference marks and (b) the reference information items, during initial operation of the steering system, detected by moving the rod from the first limit stop to the second limit stop.

14. The steering system according to claim 1, wherein at least one component of the steering system is adapted to force the rod, at rest, by restoring forces, into a position in which the position sensor is arranged between one of (a) first and second pairs of reference marks and (b) the first and second reference information items.

15. The steering system according to claim 1, wherein the rod is arranged as one of (a) a gear rack, (b) a tie rod and (c) a piston rod.

16. The steering system according to claim 1, wherein the first and second reference information items are arranged as design features of the rod.

17. The steering system according to claim 1, wherein the first and second reference information items are arranged as one of (a) bores and (b) depressions in the rod.

18. The steering system according to claim 1, wherein the first and second reference information items include one of (a) magnetic codes and (b) optical codes.

19. The steering system according to claim 8, wherein more than three pairs of reference marks are arranged on the one of (a) the rod and (b) the component part of the steering system movable with the rod.

20. The steering system according to claim 19, wherein the pairs of reference marks are spaced apart on the one of (a) the rod and (b) the component part of the steering system movable with the rod to have a defined spacing that corresponds to a rotational angle of approximately 90° at a steering handle of the steering system.

21. The steering system according to claim 1, wherein the position sensor is arranged on one of (a) a contact piece and (b) a pressure plate for the rod.

22. The steering system according to claim 1, wherein the position sensor is arranged next to the first gear element.

23. The steering system according to claim 9, wherein the rod is arranged as a gear rack, two consecutive teeth of the gear rack forming the first pair of reference marks, two teeth spaced apart by one tooth forming the second pair of reference marks.

24. The steering system according to claim 1, wherein one of (a) an auxiliary circuit of the steering system and (b) the control device is adapted to record, when an ignition of the vehicle is switched off, a magnitude and a direction of the signals of the angle-of-rotation sensor.

25. The steering system according to claim 24, further comprising a memory and a counter, the counter adapted to evaluate the signals of the angle-of-rotation sensor, the memory adapted to store the magnitude and the direction.

26. The steering system according to claim 25, further comprising an arrangement adapted to combine, when the ignition of the vehicle is switched on, a sum of the magnitude and the direction of the signals of the angle-of-rotation sensor saved in the memory with current signals of the angle-of-rotation sensor and to determine at least one of (a) the position of the rod and (b) a steering angle of the wheel of the vehicle.

27. The steering system according to claim 24, wherein one of (a) the auxiliary circuit and (b) the counter is adapted to periodically measure the signals of the angle-of-rotation sensor in an interval of approximately 10 ms.

28. The steering system according to claim 24, wherein the auxiliary circuit is adapted to remain in an activated mode for at least approximately 10 ms after each evaluation of the signals of the angle-of-rotation sensor.

29. The steering system according to claim 1, wherein an increment of the signals of the angle-of-rotation sensor is a 45° angle of rotation of one of (a) the first gear element and (b) an output shaft of the servomotor.

30. The steering system according to claim 1, wherein the control device is adapted to render a 2° maximum tolerance of a rotational angle of one of (a) the first gear element and (b) an output shaft of the servomotor.

31. The steering system according to claim 24, further comprising an arrangement adapted to compare one of (a) a position of the rod and (b) a steering angle, ascertained by one of (a) the auxiliary circuit and (b) the counter, to signals generated by the reference information items.

32. The steering system according to claim 1, wherein the steering system is arranged as one of (a) a power-steering system and (b) an electrically-assisted steering system.
